(19) United States
(12) Patent Application Publication
(10) Pub. No.: US 2015/0253239 A1
(43) Pub. Date: Sep. 10, 2015

(54) MICROPLATE FOR HIGH PERFORMANCE SPECTROSCOPIC APPLICATIONS

(71) Applicant: University of Massachusetts, Boston, MA (US)

(72) Inventors: Osman Bilsel, Holden, MA (US); Sagar V. Kathuria, Worcester, MA (US); C. Robert Matthews, Shrewsbury, MA (US)

(21) Appl. No.: 14/639,779

(22) Filed: Mar. 5, 2015

Related U.S. Application Data
(60) Provisional application No. 61/948,055, filed on Mar. 5, 2014.

(51) Int. Cl. G01N 21/03; G01N 21/33

(52) U.S. Cl. CPC G01N 21/0303; G01N 21/33; G01N 2201/022; G01N 2201/06113

(57) ABSTRACT

A microplate for making optical measurements is described. The microplate uses two optical flats, which for example can be quartz glass, and a spacer having a plurality of holes defined in the spacer. In use a first optical flat is assembled with the spacer and liquid samples of materials of interest are deposited in one or more of the plurality of holes in the spacer. The volume of each liquid sample is controlled to be sufficient to form a meniscus between the first optical flat and a second optical flat placed over the spacer. The liquid samples do not touch the walls of the holes defined in the spacer. The samples can be examined from either side of the assembled microplate. The microplate can be operated in a horizontal or a vertical orientation. The microplate is easily disassembled, cleaned and made ready for reuse.

### CROSS-REFERENCE TO RELATED APPLICATIONS

This application claims priority to and the benefit of co-pending U.S. provisional patent application Ser. No. 61/948,055, filed Mar. 5, 2014, which application is incorporated herein by reference in its entirety.

### STATEMENT REGARDING FEDERALLY FUNDED RESEARCH OR DEVELOPMENT

This invention was made with government support under grants GM23303 and GM54836 awarded by the National Institutes of Health and grant MCB1121942 awarded by the National Science Foundation. The government has certain rights in the invention.

### FIELD OF THE INVENTION

The invention relates to optical cells in general and particularly to optical cells based on microplates.

### BACKGROUND OF THE INVENTION

There is a large demand for high-throughput determinations of protein stability, protein-DNA/RNA binding, protein-protein association as well as measurement of these processes under a wide range of solution conditions for formulations development. Liquid handling robots, robotics, adoption of the microplate standard and development of microplate readers over the past decade has seen dramatic improvements in sensitivity and efficiency of sample usage. There is, however, a need in adapting these technologies for methods that require an accuracy and precision comparable to cuvet based measurements and/or use of non-standard detection methods, e.g. intrinsic fluorescence in the UV region, circular dichroism in the far-UV or small-angle x-ray scattering.

There are a wide variety of microplate designs currently in use. However, a common limitation of existing microplate designs is that they are generally incompatible with use in the UV and far-UV region. We have found and repeated confirmed, when performing experiments in the UV, that all standard plastic microplates have small molecule fluorescent impurities in them. The only exceptions to these are those made entirely from quartz (for example those manufactured by Hellma, which are quite expensive) and those which have a glass bottom with low Boron content to mimic quartz, with moderate success (for example those manufactured by made by Matrical). Additionally, these microplates are susceptible to another common problem of microplates which is the formation of a meniscus and a variable path length for each well. The meniscus also results in optical aberration and scattering that is unsuitable for high performance quantitative spectroscopic studies.

One prior art microwell plate is the NanoQuant Plate™ available from Tecan Group Ltd. Männedorf, Switzerland, which is said to be intended as a general laboratory measurement tool for the quantification of small-volume samples (2 μl) of nucleic acids in absorbance mode. It is also said that the NanoQuant Plate can be used to measure labeling efficiency of nucleic acids tagged with fluorescent dyes (instrument type-dependent).

Another prior art microwell plate is the SpectraDrop Micro-Volume Microplate available from Molecular Devices, LLC, 1311 Orleans Drive, Sunnyvale, Calif. 94089-1136. The SpectraDrop Micro-Volume Microplate consists of specially designed adapter, Teflon-coated bottom slide, and top slide with evaporation reducing spacers. However, it does not vapor isolate the wells. The user has to perform the measurement in 10 minutes or the result is not accurate.

Also known in the prior art is Garyantes, U.S. Pat. No. 6,565,813, issued May 20, 2003, which is said to disclose microtiter-like plates containing virtual wells formed by an arrangement of relatively hydrophilic domains within relatively hydrophobic fields. Assay mixtures are confined to the hydrophilic domains of the virtual wells by the edges of the hydrophobic fields. The use of virtual wells allows one to perform homogeneous and capture and wash high throughput screening assays with assay mixtures having volumes on the order of about 100 nl to 10 μl. Virtual wells also provide a means of easily moving fluids, which is particularly useful for simultaneous additions needed for kinetic studies and flash detection and washing. Methods for controlling evaporation during the dispensing of reagents as well as during incubation of high throughput screening utilizing microtiter-like plates containing virtual wells are also provided.

Also known in the prior art is Gotschy et al., U.S. Pat. No. 8,605,279, issued Dec. 10, 2013, which is said to disclose a micro cuvette assembly (1), comprising a first partial plate (2) with one or more first cuvette surfaces (3) and a second partial plate (4) which is arrangeable relative to the first partial plate and has at least one or more second cuvette surfaces (5) which, in an active position of the micro cuvette assembly (1), are arranged in register plane-parallel to the first cuvette surfaces (3) and spaced apart by a distance (6), thus forming, in the active position of the micro cuvette assembly (1), one or more micro cuvettes (7) in which a liquid volume (8) applied previously to one of the cuvette surfaces (3,5) is held between these two cuvette surfaces (3,5). The micro cuvette assembly (1) according to the present invention is characterized in that each of the first cuvette surfaces (3) of the first partial plate (2) is formed individually and completely in each case by a surface of a transparent body (10) which is accomplished as a free beam optical element and arranged in each case in an opening (9) penetrating the first partial plate (2). Also disclosed is the use of this micro cuvette assembly (1) in the carrying-out of a method for examining biological samples.

There is a need for improvements in optical microplate technology.

### SUMMARY OF THE INVENTION

According to one aspect, the invention features a microplate liquid specimen holder. The microplate liquid specimen holder comprises first and second optical flats separated by a spacer having defined therein a plurality of holes and having a thickness that defines an optical path length.

In one embodiment, a liquid situated in one of the plurality of holes is in contact with the first and the second optical flats, and is not in contact with the spacer.

In another embodiment, at least one of the first and second optical flats is fabricated from quartz.

In yet another embodiment, the spacer is fabricated from a silicone elastomer.

In a further embodiment, a sealing substance is disposed between each of the first and the second optical flats and a respective side of the spacer.

In yet a further embodiment, the sealing substance is a layer of silicone grease.

In an additional embodiment, each interface between one of the first and the second optical flats and a respective side of the spacer is impermeable to gases.

According to another aspect, the invention relates to a method of use of a microplate liquid specimen holder. The method comprises the steps of assembling a spacer having defined therein a plurality of holes and having a thickness that defines an optical path length with a first optical flat; depositing a predefined volume of at least one liquid specimen to be examined on a surface of the first optical flat in a selected one of the plurality of holes; covering the spacer with a second optical flat so that the predefined volume of the at one liquid specimen is in contact with each of the first and second optical flats and is not in contact with the spacer; examining the predefined volume of the at one liquid specimen by making an observation using electromagnetic illumination that passes through at least one of the optical flats; and recording the result of the examination.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is an exploded view of a microplate that operates according to principles of the invention.

FIG. 2 is a cross sectional view of an assembled microplate that operates according to principles of the invention.

FIG. 3 is a diagram showing the components of a microplate assembly in exploded view, with the assembled microplate shown in a holder at the bottom of the figure.

FIG. 4A is a plan view (from the top) of a microplate assembly having a rigid spacer (for example made of a rigid plastic or elastomer) and having a compressible annular elastomer inset therein at each side of the spacer so that an assembled microplate has a vapor seal provided for each well.

FIG. 4B is a cross section (side) view of the microplate assembly of FIG. 4A.

FIG. 5A is a plan view (from the top) of a microplate assembly having a rigid spacer (for example made of a rigid plastic or elastomer) and having a compressible annular elastomer inset therein at each side of the spacer so that an assembled microplate has a vapor seal provided for each well. Permanent magnets are used to provide compressive force to hold the assembly together. Examples of permanent magnets that can be used include rare earth magnets, such as Nd₂Fe₁₄B and YCo₅ magnets. Such magnets are commercially available from a number of vendors.

FIG. 5B is a cross section (side) view of the microplate assembly of FIG. 5A.

### DETAILED DESCRIPTION

The microplate design described herein overcomes the limitations previously discussed in a cost effective and convenient design.

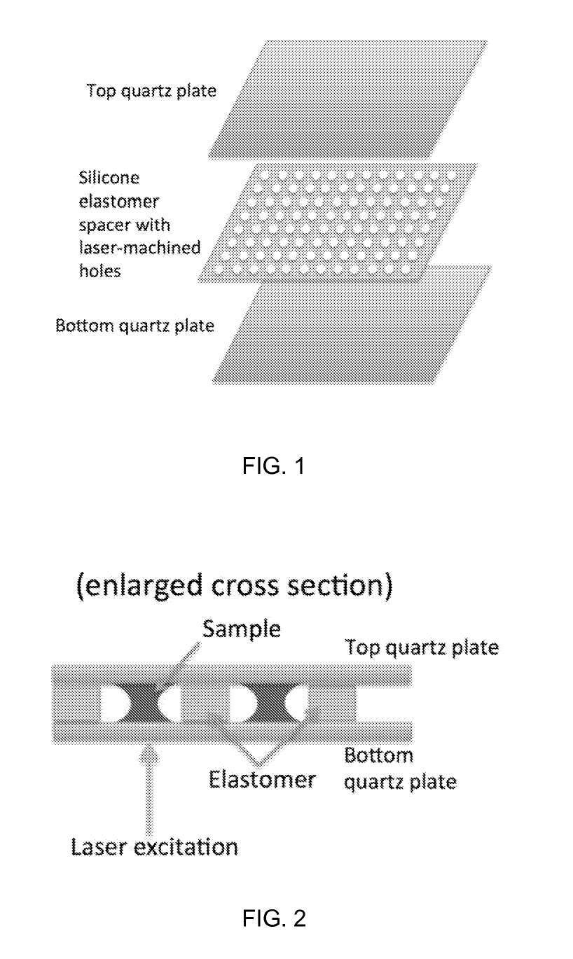

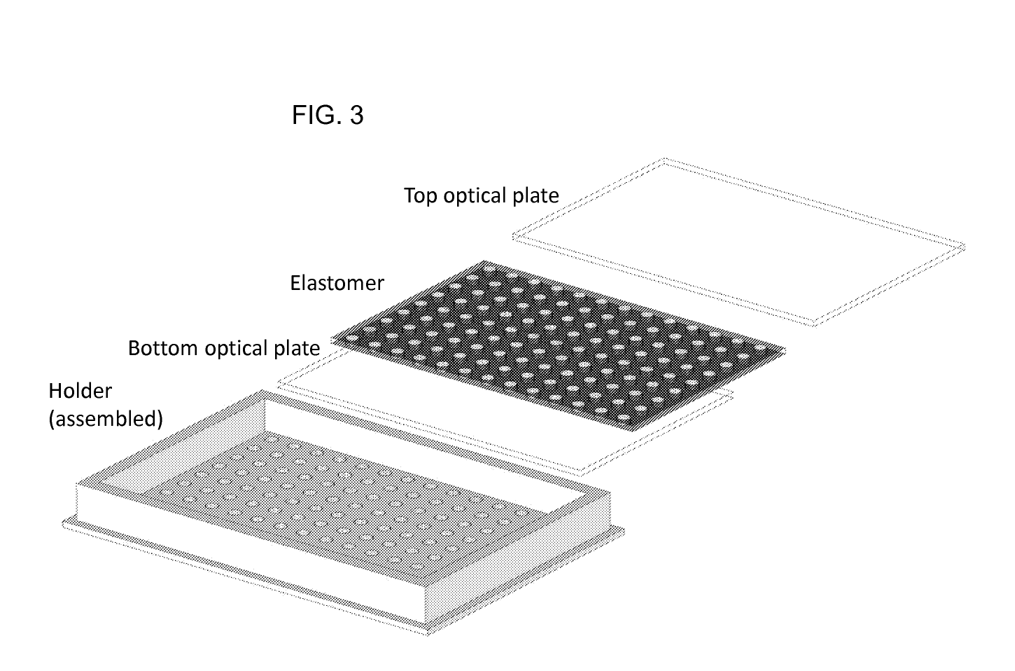

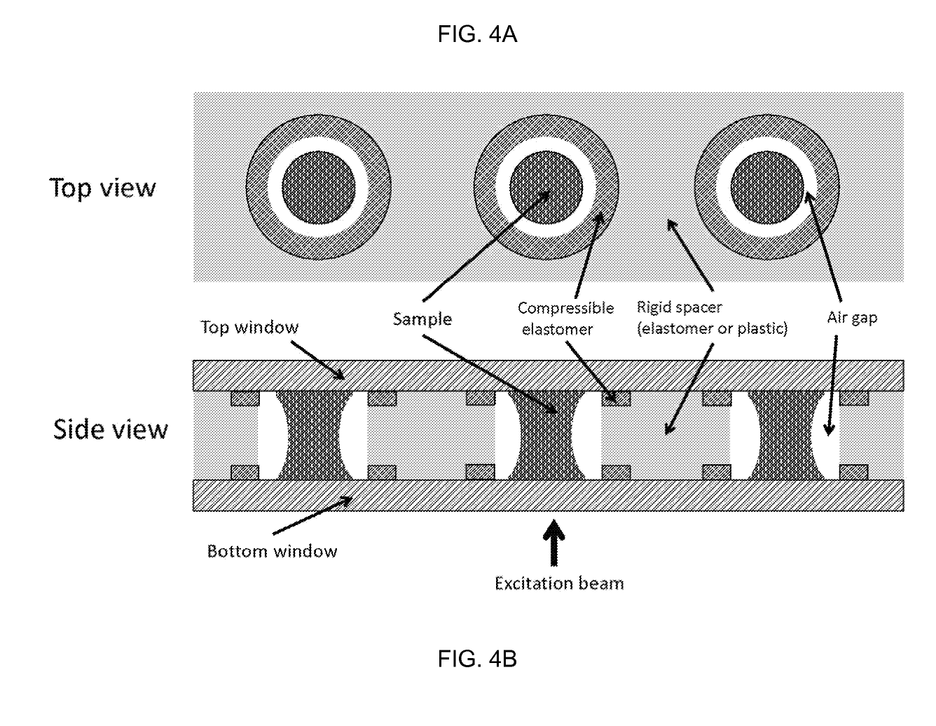

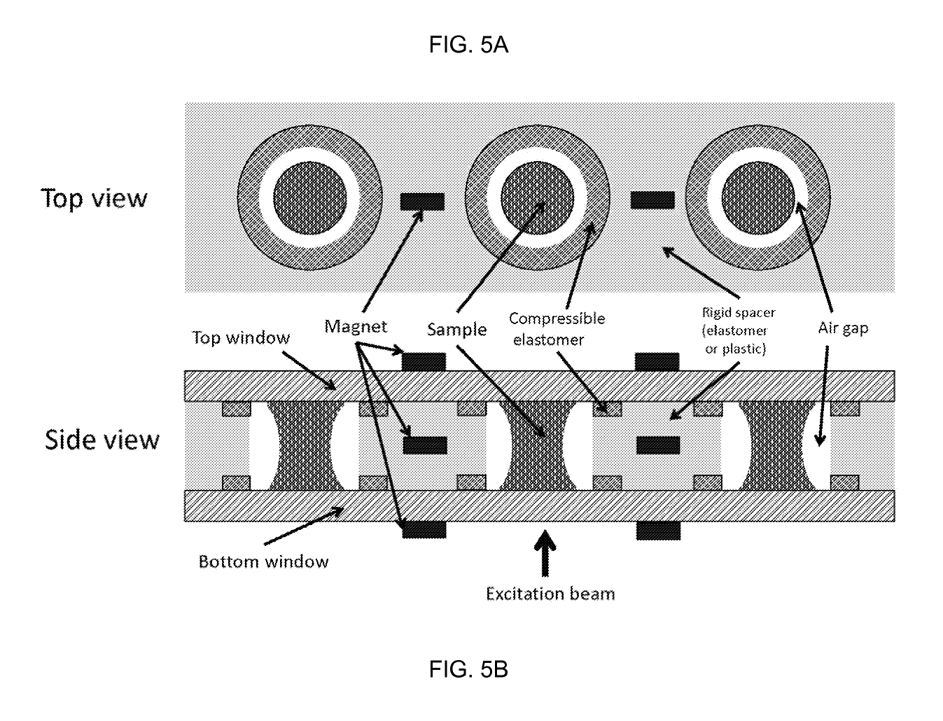

FIG. 1 is an exploded view of a microplate that operates according to principles of the invention. The microplate is simple and utilizes a silicon elastomer spacer template registered on top of a first quartz plate. In some embodiments, the user can specify the optical properties of the plate according to their needs, i.e. UV transmission or other desired optical property. The elastomer spacer template has a hole pattern (for example 96, 384 or 1536 holes, similar to standard microplates) that in some embodiments is produced by laser machining, individually or in batch. The laser machining process is a standard industry tool and requires approximately 10 min per template. In other embodiments, the holes can be manufactured by other means such as other types of drilling, casting a spacer with holes, or cutting a spacer with holes by a stamping process. A second quartz plate is used to cover the elastomer spacer template so as to provide individual wells that are bounded on opposite sides by optical flats which are defined by the respective surfaces of the quartz plates adjacent the elastomer spacer. The elastomer spacer can be made from any material that is sufficiently chemically inert relative to the liquid samples to be examined that no chemical impurities flow from the elastomer spacer to the samples to be examined. Because the spacer is constructed with two opposed parallel flat faces, the optical length of each well defined by the assembled spacer and quartz plates is the same as every other well.

The samples are deposited into the wells defined by the hole pattern in the spacer using a robot (e.g., the Phoenix robot that is available in our department can deposit microliter volumes with a positional accuracy of microns). The top plate is then registered over the elastomer to form a fixed path length sample compartment for all of the wells. The liquid volume is calibrated to fill the space in each well, touching the top and bottom quartz plates but not touching the elastomer side walls. The idea is very similar to the preparation of a cover slip but scaled and applied to microplates. The microplates are locked into position and ready to be mounted into the plate reader or spectrometer of the user's choice. The microplate can be mounted vertically, which facilitates incorporation into circular dichroism instruments or SAXS beamlines. As desired, electromagnetic illumination is applied to make a measurement of a property of the sample in any well. The result of the measurement is recorded in any convenient form.

Each well is vapor sealed with respect to the exterior and with respect to all other wells. This can be achieved in several ways. In one embodiment, the elastomer has a compressibility that is sufficient to seal against the top and the bottom quartz or glass windows when made into an assembled structure, yet is still able to act as a spacer with a specific path length. Alternatively, the top and bottom quartz or glass windows can be coated with a sealing film (e.g., silicone-based high vacuum grease composed of amorphous silica, poly-dimethylsiloxane and hydroxy terminated dimethylsiloxane) to facilitate the formation of a vapor seal with the elastomer spacer. A mask can be used to apply the film only to where the spacer would contact the top and bottom windows. In another embodiment, the sealing film can be applied to one side of the spacer, and assembled to one window, and another sealing film can be applied to the other side of the spacer, which is then assembled with the other window. The thin film can be removed using a high pH detergent solution, allowing the user to reuse the windows. In another embodiment the elastomer may be manufactured from two or more types of elastomer or plastic. A thin layer of compressible elastomer may be placed on the top and bottom of a more rigid elastomer, plastic or other material (e.g., Delrin or PEEK). In this embodiment, the compressible elastomer would be a circular (or other) pattern around the perimeter of each hole pattern. The compression on the elastomer that forms the vapor seal may be applied either by pressure from a mechanical clamp or by pressure from small magnets in the top and bottom plates.

### Principle of Operation

In the systems of the invention, solid surfaces and air (or a controlled atmosphere) are in contact with the liquid sample. The wetting of the surfaces by the liquid depends on such parameters as the surface tension of the liquid-solid interface, the surface tension of a gas in contact with the liquid and the surface and the surface tension of the gas and the solid, the density of the liquid, properties of the solid that is being contacted by the liquid, the acceleration of gravity and various experimental parameters. In general, one can calculate the length of a meniscus can be maintained in the geometry illustrated in FIG. 1 and FIG. 2. Therefore, assembling a system that will provide a stable meniscus is a reasonably well understood problem, which is readily checked by simple experiments.

In some embodiments, one or both of the optical flats can include a surface treatment that constrains the liquid to remain in a predefined position. For example, using a water-based liquid, a hydrophobic annular region may be provided about a central hydrophilic region of a surface of an optical flat. The hydrophilic region can be positioned so as to be in the center of a hole in the spacer so that the liquid is optically accessible through the face plate when the face plate is assembled with the spacer. The hydrophobic treatment may be chemical (e.g., a substance is hydrophobic may be coated on the surface of the optical flat).

### Features of the Apparatus and Method

The novel aspects of the invention are believed to be:

Optical quality quartz windows can be used. This gives rise to a low-background in intrinsic fluorescence experiments (i.e., Trp or Tyr fluorescence).

Each well is vapor sealed and isolated from all other wells, thus avoiding evaporation over extended time periods and cross-contamination or concentration fluctuations from vapor diffusion between wells.

A pair of S1UV quartz windows can be used, which makes the unit UV and far-UV compatible.

The microplate can operate in horizontal or vertical orientation (i.e., for circular dichroism or SAXS)

The microplate can be fabricated from 100% biocompatible materials

The microplate is low cost, reusable, easy to clean and easy to assemble.

One can obtain cuvet performance in a microplate format (because there are no meniscus issues)

The microplate provides equal performance for read operations from the top or the bottom.

The microplate can be provided in standard microplate format (i.e., 96, 384 or 1536 well format) as well as custom formats as needed.

The microplate can be provided with variable quartz plate thickness (170 micron to several mm, suitable for high NA objectives).

The microplate can be provided with optical quality quartz windows (so that there will be low-background).

The technology is applicable to uses such as determining a formulation parameter space, screening for protein-protein and protein-RNA/DNA interactions, ligand binding and protein denaturation (chemical or thermal), as well as other uses.

In alternative embodiments, the optical flats can be made from other transparent materials, such as plastic or window glass if there is no need to operate in the UV.

In alternative embodiments, the spacer can have any convenient number of holes defined therein. The holes can be produced in any pattern that is desired, such as a square pattern.

In alternative embodiments, the spacer can be fabricated from a compliant material such as plastic sheet.

In an alternative embodiment, one of the optical flats can be a mirror, such that an optical beam entering through a transparent optical flat makes two passes through a specimen held between the transparent optical flat and the mirror, thereby doubling the optical path of the illumination in the specimen. This may be useful to examine materials at very low concentration.

### Definitions

Unless otherwise explicitly recited herein, any reference to an electronic signal or an electromagnetic signal (or their equivalents) is to be understood as referring to a non-volatile electronic signal or a non-volatile electromagnetic signal.

Unless otherwise explicitly recited herein, any reference to “record” or “recording” is understood to refer to a non-volatile or non-transitory record or a non-volatile or non-transitory recording.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A microplate liquid specimen holder, comprising:
first and second optical flats separated by a spacer having defined therein a plurality of holes, said spacer having a thickness that defines an optical path length.

2. The microplate liquid specimen holder of claim 1, wherein a liquid situated in one of said plurality of holes is in contact with said first and said second optical flats, and is not in contact with said spacer.

3. The microplate liquid specimen holder of claim 1, wherein at least one of said first and second optical flats is fabricated from quartz.

4. The microplate liquid specimen holder of claim 1, wherein said spacer is fabricated from a silicone elastomer.

5. The microplate liquid specimen holder of claim 1, wherein a sealing substance is disposed between each of said first and said second optical flats and a respective side of said spacer.

6. The microplate liquid specimen holder of claim 1, wherein said sealing substance is a layer of silicone grease.

7. The microplate liquid specimen holder of claim 1, wherein each interface between one of said first and said second optical flats and a respective side of said spacer is impermeable to gases.

8. A method of use of a microplate liquid specimen holder, comprising the steps of:
assembling a spacer having defined therein a plurality of holes and having a thickness that defines an optical path length with a first optical flat;
depositing a predefined volume of at least one liquid specimen to be examined on a surface of the first optical flat in a selected one of the plurality of holes;
covering the spacer with a second optical flat so that the predefined volume of the at one liquid specimen is in contact with each of the first and second optical flats and is not in contact with the spacer;
examining the predefined volume of the at one liquid specimen by making an observation using electromagnetic illumination that passes through at least one of the optical flats; and
recording the result of the examination.
